(19) United States
(12) Patent Application Publication
(10) Pub. No.: US 2010/0289859 A1
(43) Pub. Date: Nov. 18, 2010

(54) SURFACE-TREATED PIGMENT, INK COMPOSITION, AND INK-JET RECORDING METHOD

(75) Inventors: Takashi OYANAGI, Matsumoto-shi (JP); Tsuyoshi SANO, Shiojiri-shi (JP); Takayoshi KAGATA, Shiojiri-shi (JP); Hiroki NAKANE, Matsumoto-shi (JP)

Correspondence Address: LADAS & PARRY, 26 West 61st Street, New York, NY, 10023, US

(73) Assignee: SEIKO EPSON CORPORATION

(21) Appl. No.: 12/778,496

(22) Filed: May 12, 2010

(30) Foreign Application Priority Data
May 18, 2009 (JP) 2009-119746

(51) Int. Cl. B41J 2/01; C08K 5/5415

(52) U.S. Cl. 347/102; 524/264

(57) ABSTRACT

A surface-treated pigment is formed of a metal pigment including flat particles whose surfaces are treated with an alkoxysilane compound having a group having an unsaturated double bond between carbon atoms.

### BACKGROUND

1. Technical Field

The present invention relates to surface-treated pigments, ink compositions, and ink-jet recording methods, and particularly to a surface-treated pigment, an ink composition, and an ink-jet recording method that allow metallic printing with improved properties.

2. Related Art

A coating with a metallic gloss is typically formed on a printing material using a print ink containing a gold or silver powder formed of, for example, brass or aluminum microparticles as a pigment, or by foil stamping using metal foil or thermal transfer using metal foil. These methods, however, are limited to recording media resistant to heat or deformation.

Some applied techniques recently used in printing use surface treatment of a metal pigment for increased glossiness.

For example, in order to provide a novel surface-treatment agent and a novel surface-treated flake-like pigment, treated with the surface treatment agent, useful for paints and inks, JP-A-8-283604 discloses a surface treatment agent, for flake-like pigments, containing a polyglycidyl ether compound, a polyglycidyl ester compound, and/or a diglycidyl polysiloxane compound; a flake-like pigment including particles whose surfaces are formed of a metal oxide layer and/or a hydrous metal oxide layer and are treated with the surface treatment agent; and a method for producing the flake-like pigment.

In addition, JP-T-2005-501955 discloses an ink composition including a binder system, water, and a pigment selected from the group of interference pigments including a layered stack of different materials. At least one of the layers is a reflective layer having at least one chemically exposed surface, and at least one of the layers is a dielectric layer having at least one chemically exposed surface. The materials include one or more corrosion-sensible metals and/or inorganic metal compounds. The chemically exposed surfaces of the reflective layer and the dielectric layer are substantially covered at the edge of the stack of layers by a passivating agent selected from the group of anionic tensides, preferably from the group consisting of organic esters and fluorinated organic esters of phosphoric acid. The reflective layers of the optically variable pigments are selected from the group of metals such as aluminum.

Metallic printing using such treated metal pigments, however, is still unsatisfactory in providing a metallic specular gloss.

### SUMMARY

An advantage of some aspects of the invention is that it provides a pigment, an ink composition, and an ink-jet recording method using the ink composition that allow metallic specular printing with excellent properties by focusing on surface treatment techniques for metal pigments.

As a result of an intensive study, the inventors have found that the above advantage is provided by a surface-treated pigment formed of a metal pigment including flat particles whose surfaces are treated with a particular compound, an ink composition containing the surface-treated pigment, and an ink-jet recording method using the ink composition.

A surface-treated pigment according to a first aspect of the invention is formed of a metal pigment including flat particles whose surfaces are treated with an alkoxysilane compound having a group having an unsaturated double bond between carbon atoms. The group having an unsaturated double bond between carbon atoms is, for example, a group having —C═CH₂, such as a methacryloxy group, an acryloxy group, a vinyl group, or a styryl group.

If the major axis of the flat particles in a plane is defined as X, the minor axis thereof is defined as Y, and the thickness thereof is defined as Z, the 50% average particle size R50 determined in terms of equivalent circle diameter from the area of the flat particles in the X-Y plane is preferably 0.5 to 3 μm, and R50/Z>5 is preferably satisfied.

The maximum particle size Rmax determined in terms of equivalent circle diameter from the area of the flat particles in the X-Y plane is preferably 10 μm or less.

The metal pigment is preferably aluminum or an aluminum alloy.

The metal pigment is preferably formed by crushing a metal deposited film.

An ink composition according to a second aspect of the invention contains the above surface-treated pigment, an organic solvent, and a resin.

The concentration of the surface-treated pigment in the ink composition is preferably 0.1% to 3.0% by weight.

The organic solvent preferably contains one or more alkylene glycol ethers that are liquid at normal temperature and pressure.

The organic solvent is preferably a mixture of an alkylene glycol diether, an alkylene glycol monoether, and a lactone.

The resin is preferably at least one resin selected from the group consisting of polyvinyl butyral, cellulose acetate butyrate, and polyacrylic polyols.

An ink-jet recording method according to a third aspect of the invention includes ejecting droplets of the above ink composition onto a recording medium to perform recording. The amount of ink composition ejected onto the recording medium is 0.1 to 100 mg/cm².

The ink composition is preferably ejected by a non-heating method.

The recording medium is preferably subjected to printing by heating.

The heating temperature is preferably 30° C. to 80° C.

The heating is preferably performed before, at the same time as, and/or after printing.

According to the above aspects of the invention, an image having a highly metallic gloss can be formed on a recording medium using a metal pigment including flat particles whose surfaces are treated with a particular compound.

In addition, an alkoxysilane compound having a group having an unsaturated double bond between carbon atoms reacts with chemically active functional groups present on the surfaces of the pigment particles to inactivate the chemically active functional groups, thus decreasing the reactivity of the surface-treated pigment with water. This improves heat resistance and water resistance and therefore inhibits generation of hydrogen gas due to a reaction between metal and water.

### DESCRIPTION OF EXEMPLARY EMBODIMENTS

Pigment Dispersion

A surface-treated pigment according to an embodiment of the invention is formed of a metal pigment (also referred to as “metallic pigment”) including flat particles whose surfaces are treated with an alkoxysilane compound having a group having an unsaturated double bond between carbon atoms.

With the above structure, the surface-treated pigment according to this embodiment can be used as, for example, an ink composition containing the pigment to form an image having a metallic gloss on a recording medium.

The alkoxysilane compound, used in this embodiment, having a group having an unsaturated double bond between carbon atoms preferably has an alkoxy group having one to three carbon atoms in view of reactivity with the metal pigment. In addition, the group having an unsaturated double bond between carbon atoms is a group having —C═CH₂, preferably, such as a methacryloxy group, an acryloxy group, a vinyl group, or a styryl group. Examples of such compounds include 3-methacryloxypropyltrimethoxysilane, 3-acryloxypropyltrimethoxysilane, 3-methacryloxypropylmethyldiethoxysilane, 3-methacryloxypropylmethyldimethoxysilane, vinyltrimethoxysilane, vinyltriethoxysilane, p-styryltrimethoxysilane, and 3-methacryloxypropyltriethoxysilane.

In this embodiment, the surface-treated pigment can be produced by, for example, adding the alkoxysilane compound having a group having an unsaturated double bond to a pigment dispersion containing the metallic pigment to a concentration of 0.01 to 0.05 mol/L and allowing them to react at 10° C. to 70° C. for 4 to 48 hours.

The metallic pigment used in this embodiment includes, for example, flat particles formed by crushing a metal deposited film. If the major axis of the flat particles in a plane is defined as X, the minor axis thereof is defined as Y, and the thickness thereof is defined as Z, the 50% average particle size R50 determined in terms of equivalent circle diameter from the area of the flat particles in the X-Y plane is 0.5 to 3 μm, and R50/Z>5 is satisfied.

The term “flat particles” refers to particles having a substantially flat surface (X-Y plane) and a substantially uniform thickness (Z). Because the flat particles are formed by crushing a metal deposited film, metal particles having a substantially flat surface and a substantially uniform thickness can be yielded. Thus, the major axis of the flat particles in a plane can be defined as X, the minor axis thereof can be defined as Y, and the thickness thereof can be defined as Z.

The term “equivalent circle diameter” refers to the diameter of a circle having the same projected area as the substantially flat surface (X-Y plane) of the flat particles of the metallic pigment. For example, if the substantially flat surface (X-Y plane) of the flat particles of the metallic pigment is a polygon, the equivalent circle diameter of the flat particles of the metallic pigment refers to the diameter of a circle into which a projection of the polygon is transformed.

The 50% average particle size R50 determined in terms of equivalent circle diameter from the area of the flat particles in the X-Y plane is preferably 0.5 to 3 μm, more preferably 0.75 to 2 μm, in view of metallic glossiness and print stability. If the 50% average particle size R50 falls below 0.5 μm, the metallic pigment lacks glossiness. On the other hand, if the 50% average particle size R50 exceeds 3 μm, the metallic pigment has low print stability.

In addition, the relationship between the 50% average particle size R50 determined in terms of equivalent circle diameter and the thickness Z preferably satisfies R50/Z>5 in view of ensuring a highly metallic gloss. If R50/Z is 5 or less, the metallic pigment undesirably lacks a metallic gloss.

The maximum particle size Rmax determined in terms of equivalent circle diameter from the area of the flat particles in the X-Y plane is preferably 10 μm or less in view of preventing clogging with an ink composition in an ink-jet recording apparatus. If the maximum particle size Rmax is 10 μm or less, it is possible to prevent clogging of, for example, nozzles of an ink-jet recording apparatus and mesh filters disposed in ink channels.

The metallic pigment is preferably aluminum or an aluminum alloy in view of cost and also in view of providing a metallic gloss. If an aluminum alloy is used, another metallic or nonmetallic element alloyed with aluminum may be any element having properties such as possessing a metallic gloss. Preferably used is at least one of silver, gold, platinum, nickel, chromium, tin, zinc, indium, titanium, copper, alloys thereof, and mixtures thereof.

According to an example of a method for producing the metallic pigment, first, a composite pigment material is prepared by sequentially stacking a releasing resin layer and a metal or alloy layer on a surface of a sheet-like substrate. The metal or alloy layer is released from the sheet-like substrate at the interface between the metal or alloy layer and the releasing resin layer and is crushed and pulverized to yield flat particles. Separated from the resultant flat particles are those where, if the major axis of the flat particles in a plane is defined as X, the minor axis thereof is defined as Y, and the thickness thereof is defined as Z, the 50% average particle size R50 determined in terms of equivalent circle diameter from the area of the flat particles in the X-Y plane is 0.5 to 3 μm and which satisfies R50/Z>5.

The major axis X and the minor axis Y of the metallic pigment (flat particles) in a plane and the equivalent circle diameter thereof can be measured using a particle image analyzer. The particle image analyzer used may be, for example, the flow particle image analyzer FPIA-2100, FPIA-3000, or FPIA-3000S manufactured by Sysmex Corporation.

The particle size distribution (CV) of the metallic pigment (flat particles) is determined by the following equation (Equation 1):

CV=standard deviation of particle size distribution/average of particle size×100

The CV is preferably 60 or less, more preferably 50 or less, and most preferably 40 or less. A metallic pigment whose CV is 60 or less provides superior print stability.

The metal or alloy layer is preferably formed by vacuum evaporation, ion plating, or sputtering.

The metal or alloy layer has a thickness of 20 to 100 nm. Accordingly, the pigment has an average thickness of 20 to 100 nm. If the metallic pigment has a thickness of 20 nm or more, it has high reflectivity and shininess, thus providing a higher performance as a metallic pigment. If the metallic pigment has a thickness of 100 nm or less, it has low apparent specific gravity, thus providing sufficient dispersion stability.

The releasing resin layer of the composite pigment material, serving as an undercoat layer for the metal or alloy layer, is a releasing layer for improving ease of release from the surface of the sheet-like substrate. The resin used for the releasing resin layer may be, for example, polyvinyl alcohol, polyvinyl butyral, polyethylene glycol, polyacrylic acid, polyacrylamide, a cellulose derivative, an acrylate polymer, or a modified nylon resin.

The releasing resin layer is formed by, for example, applying a solution containing one of the above resins or a mixture of two or more onto the sheet-like substrate and drying the coating. The coating solution may contain an additive such as a viscosity modifier.

The releasing resin layer is formed by a common coating method such as gravure coating, roll coating, blade coating, extrusion coating, dip coating, or spin coating. After the coating and drying, the surface is smoothened by calendering where needed.

The thickness of the releasing resin layer is preferably, but not limited to, 0.5 to 50 μm, more preferably 1 to 10 μm. If the thickness falls below 0.5 μm, the amount of releasing resin layer may be insufficient to serve as a dispersing resin. If the thickness exceeds 50 μm, the pigment layer tends to peel from the releasing resin layer at the interface therebetween when rolled.

The sheet-like substrate used may be a releasable film such as, but not limited to, a polytetrafluoroethylene film, a polyethylene film, a polypropylene film, a polyester film (e.g., polyethylene terephthalate), a polyamide film (e.g., nylon 66 or nylon 6), a polycarbonate film, a triacetate film, or a polyimide film. The sheet-like substrate is preferably formed of polyethylene terephthalate or a copolymer thereof.

The thickness of the sheet-like substrate is preferably, but not limited to, 10 to 150 μm. If the sheet-like substrate has a thickness of 10 μm or more, ensures ease of handling, for example, in a production process. If the sheet-like substrate has a thickness of 150 μm or less, it is flexible and can be smoothly rolled and released.

In addition, the metal or alloy layer may be held between protective layers, as illustrated in JP-A-2005-68250. The protective layers used may be, for example, silicon oxide layers or protective resin layers.

The silicon oxide layers may be any type of layer containing silicon oxide and are preferably formed with a silicon alkoxide such as a tetraalkoxysilane or a polymer thereof by the sol-gel process.

The silicon oxide layers are formed by applying and firing an alcohol solution containing a silicon alkoxide or a polymer thereof.

The protective resin layers may be formed of any resin insoluble in a dispersion medium, such as polyvinyl alcohol, polyethylene glycol, polyacrylic acid, polyacrylamide, or a cellulose derivative, and is preferably formed of polyvinyl alcohol or a cellulose derivative.

The protective resin layers are formed by, for example, applying and drying an aqueous solution containing one of the above resins or a mixture of two or more. The coating solution may contain an additive such as a viscosity modifier.

The silicon oxide layers or the protective resin layers are formed by applying a solution in the same manner as in the formation of the releasing resin layer.

The thickness of the protective layers is preferably, but not limited to, 50 to 150 nm. If the thickness falls below 50 nm, the protective layers lack mechanical strength. If the thickness exceeds 150 nm, the protective layers may be difficult to crush and disperse because of excessive strength and may also peel from the metal or alloy layer at the interfaces therebetween.

In addition, colorant layers may be disposed between the protective layers and the metal or alloy layer, as illustrated in JP-A-2005-68251.

The colorant layers are introduced to produce a composite pigment of any color and may be any type of layer that can contain a colorant capable of imparting any tone or hue in addition to the metallic gloss and shininess of the metallic pigment. The colorant used in the colorant layers may be either a dye or a pigment. In addition, a known dye or pigment may be used.

The term “pigment” used herein for the colorant layers refers to a pigment such as a natural pigment, a synthetic organic pigment, or a synthetic inorganic pigment, as defined in the field of general pigment chemistry, and differs from a pigment having a layered structure, such as the composite pigment according to this embodiment.

The colorant layers may be formed by any method, preferably, by coating.

In addition, if the colorant layers contain a pigment as a colorant, they preferably further contain a colorant-dispersing resin. The colorant layers are preferably formed by dispersing or dissolving the pigment, the colorant-dispersing resin, and optionally other additives in a solvent, forming a uniform liquid film by spin coating, and drying it into a thin resin film.

In the production of the composite pigment material, it is preferable in view of work efficiency to form both the colorant layers and the protective layers by coating.

The composite pigment material may be formed of a plurality of stacks including the releasing resin layer, the metal or alloy layer, and the protective layers. In this case, the thickness of the entire stack including the plurality of metal or alloy layers, that is, the thickness excluding those of the sheet-like substrate and the releasing resin layer directly disposed thereon (e.g., the thickness of a stack including a metal or alloy layer, a releasing resin layer, and a metal or alloy layer or a stack including a releasing resin layer and a metal or alloy layer) is preferably 5,000 nm or less. If the thickness is 5,000 nm or less, the composite pigment material does not crack or peel when rolled, thus having superior storage stability. This composite pigment material is also preferred because it has superior shininess when processed into a pigment.

It is also possible to sequentially stack the releasing resin layer and the metal or alloy layer on each side of the sheet-like substrate, although the structure is not limited to those shown above.

The composite pigment material may be released from the sheet-like substrate by any method, preferably, by dipping the composite pigment material in a liquid, or by dipping the composite pigment material in a liquid and at the same time pulverizing the released composite pigment by ultrasonic treatment.

The pigment thus produced can be simply dispersed in a solvent to prepare a stable dispersion because the releasing resin layer functions as a protective colloid. In an ink composition containing the pigment, additionally, the resin derived from the releasing resin layer facilitates adhesion to a recording medium such as paper.

Ink Composition

An ink composition according to this embodiment contains the metallic pigment subjected to surface treatment with the particular compound described above (herein also referred to as “surface-treated pigment”), an organic solvent, and a resin.

For an ink set including only one metallic ink composition containing a surface-treated metallic pigment, the concentration of the metallic pigment in the ink composition is preferably 0.1% to 3.0% by weight, more preferably 0.25% to 2.5% by weight, and most preferably 0.5% to 2% by weight.

For an ink set including a plurality of metallic ink compositions containing surface-treated metallic pigments, preferably, the concentration of the metallic pigment in at least one of the ink compositions is 0.1% to less than 1.5% by weight, and the concentration of the metallic pigment in at least one other ink composition is 1.5% to 3.0% by weight.

If the concentration of the metallic pigment in the ink composition is 0.1% to less than 1.5% by weight, a half-mirror gloss, that is, a glossy but see-through appearance, can be formed by applying an amount of ink insufficient to cover a printing surface, and a highly metallic gloss can be formed by applying an amount of ink sufficient to cover a printing surface. Accordingly, for example, such an ink composition is suitable for forming a half-mirror image or a highly metallic gloss on a transparent recording medium. On the other hand, if the concentration of the metallic pigment in the ink composition is 1.5% to 3.0% by weight, a matt metallic appearance without high glossiness can be formed because the pigment particles are randomly arranged on a printing surface. Accordingly, for example, such an ink composition is suitable for forming a shield layer on a transparent recording medium.

Preferably used as the organic solvent is a polar organic solvent such as an alcohol (e.g., methyl alcohol, ethyl alcohol, propyl alcohol, butyl alcohol, isopropyl alcohol, or a fluorinated alcohol), a ketone (e.g., acetone, methyl ethyl ketone, or cyclohexanone), a carboxylate ester (e.g., methyl acetate, ethyl acetate, propyl acetate, butyl acetate, methyl propionate, or ethyl propionate), or an ether (e.g., diethyl ether, dipropyl ether, tetrahydrofuran, or dioxane).

In particular, the organic solvent preferably contains one or more alkylene glycol ethers that are liquid at normal temperature and pressure.

Alkylene glycol ethers include ethylene glycol ethers and propylene glycol ethers based on aliphatic groups such as methyl, n-propyl, i-propyl, n-butyl, i-butyl, hexyl, and 2-ethylhexyl groups; groups, such as an allyl group, having a double bond; and a phenyl group. These alkylene glycol ethers have no color and little odor, show both properties as an alcohol and properties as an ether because they have an ether group and a hydroxyl group in the molecule thereof, and are liquid at normal temperature. In addition, the alkylene glycol ethers include monoethers, where only one hydroxyl group is substituted, and diethers, where both hydroxyl groups are substituted, which can be used in combination.

In particular, the organic solvent is preferably a mixture of an alkylene glycol diether, an alkylene glycol monoether, and a lactone.

Examples of alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Examples of lactones include γ-butyrolactone, δ-valerolactone, and ε-caprolactone.

Examples of the resin used for the ink composition include acrylic resins, styrene-acrylic resins, rosin-modified resins, terpene resins, polyester resins, polyamide resins, epoxy resins, vinyl chloride resins, vinyl chloride-vinyl acetate copolymers, cellulose resins (such as cellulose acetate butyrate and hydroxypropyl cellulose), polyvinyl butyral, polyacrylic polyols, polyvinyl alcohol, and polyurethanes.

The resin used can also be a nonaqueous polymer microparticle emulsion (nonaqueous dispersion (NAD)), that is, a dispersion in which microparticles of, for example, a polyurethane resin, an acrylic resin, or a polyacrylic polyol resin are stably dispersed in an organic solvent.

For polyurethane resins, for example, Sanprene IB-501 and Sanprene IB-F370 are available from Sanyo Chemical Industries, Ltd. For polyacrylic polyol resins, for example, N-2043-60MEX is available from Harima Chemicals, Inc.

The resin emulsion is preferably added in an amount of 0.1% to 10% by weight of the amount of ink composition to further improve adhesion of the pigment to a recording medium. If the resin emulsion is excessively added, the ink composition has low print stability. If the resin emulsion is insufficiently added, the ink composition has insufficient adhesion.

The ink composition may contain at least one compound selected from the group consisting of glycerol, polyalkylene glycols, and saccharides. The total amount of compound added is, for example, 0.1% to 10% by weight of the amount of ink composition.

This prevents drying of the ink and clogging to stabilize ink ejection, thus improving the image quality of a recorded material.

A polyalkylene glycol is a linear polymer compound having ether bonds repeated in the main chain thereof and is produced by, for example, ring-opening polymerization of a cyclic ether.

Examples of polyalkylene glycols include polymers such as polyethylene glycol and polypropylene glycol, ethylene oxide-propylene oxide copolymers, and derivatives thereof. For copolymers, any type of copolymer, such as a random copolymer, a block copolymer, a graft copolymer, or an alternating copolymer, may be used.

A preferred example of a polyalkylene glycol is represented by the following formula:

HO—(CₙH₂ₙO)ₘ—H

(where n is an integer of 1 to 5 and m is an integer of 1 to 100).

In the above formula, the integer n in (CₙH₂ₙO)ₘ may be a single constant or a combination of two or more constants within the above range. For example, if n is 3, (C₃H₆O)ₘ is given, and if n is a combination of 1 and 4, (CH₂O—C₄H₈O)ₘ is given. In addition, the integer m may be a single constant or a combination of two or more constants within the above range. For example, if m is a combination of 20 and 40 in the above example, (CH₂O)₂₀—(C₄H₈O)₄₀ is given, and if m is a combination of 10 and 30, (CH₂O)₁₀—(C₄H₈O)₃₀ is given. In addition, the integers n and m may be selected in any combination within the above ranges.

Examples of saccharides include monosaccharides such as pentoses, hexoses, heptoses, and octoses, polysaccharides such as disaccharides, trisaccharides, and tetrasaccharides, and derivatives thereof, including sugar alcohols, reduced derivatives such as deoxy sugars, oxidized derivatives such as aldonic acids and uronic acids, dehydrated derivatives such as glycoseen, amino sugars, and thio sugars. The term “polysaccharides” is a broad term for saccharides including naturally found substances such as alginic acid, dextrin, and cellulose.

The ink composition may contain at least one acetylene glycol surfactant and/or silicone surfactant. The surfactant is added in an amount of, for example, 0.01% to 10% by weight based on the content of the pigment in the ink composition.

This improves wettability of the ink composition over a recording medium, thus providing quick adhesion.

Preferred examples of the acetylene glycol surfactant include Surfynol 465 (trademark) and Surfynol 104 (trademark) (which are names of products manufactured by Air Products and Chemicals, Inc.), and Olfine STG (trademark) and Olfine E1010 (trademark) (which are names of products manufactured by Nissin Chemical Industry Co., Ltd.).

The silicone surfactant used is preferably a polyester-modified silicone or a polyether-modified silicone. Examples of the silicone surfactant include BYK-347, BYK-348, BYK-UV3500, BYK-UV3570, BYK-UV3510, and BYK-UV3530 (manufactured by BYK Japan KK).

The ink composition can be prepared by a known method. For example, first, a pigment dispersion is prepared by mixing the metallic pigment, a dispersant, and a solvent and processing the mixture in, for example, a ball mill, a bead mill, an ultrasonic homogenizer, or a jet mill. Next, a pigment dispersion containing a surface-treated metallic pigment is prepared by, for example, adding an alkoxysilane compound having a group having an unsaturated double bond between carbon atoms to the dispersion. The pigment dispersion is adjusted so as to have the desired ink properties. Subsequently, a pigment ink composition can be prepared by adding a binder resin, a solvent, and other additives (such as a dispersion aid and a viscosity modifier) with stirring.

It is also possible to prepare a composite pigment dispersion by subjecting the composite pigment material to ultrasonic treatment in a solvent before mixing it with the required ink solvent, or to prepare an ink composition by directly subjecting the composite pigment material to ultrasonic treatment in the ink solvent.

The ink composition preferably has a surface tension of 20 to 50 mN/m, although the physical properties thereof are not particularly limited. If the surface tension falls below 20 mN/m, ejection of ink droplets may be difficult because the ink composition wets over a surface of an ink-jet recording printer head or leaks therefrom. If the surface tension exceeds 50 mN/m, excellent printing may be difficult because the ink composition does not wet over a surface of a recording medium.

Ink Set

An ink set according to this embodiment includes a plurality of ink compositions described above, and they have different metal pigment concentrations.

Preferably, the concentration of the metallic pigment in at least one of the ink compositions is 0.1% to less than 1.5% by weight, and the concentration of the metallic pigment in at least one other ink composition is 1.5% to 3.0% by weight.

Recording Apparatus

A recording apparatus according to this embodiment is an ink-jet recording apparatus including the ink set described above.

Ink-Jet Recording Method

An ink-jet recording method according to this embodiment includes ejecting droplets of the above ink composition onto a recording medium to perform recording.

In view of angular dependence, it is preferable to form an image having a metallic gloss whose specular glossiness according to JIS 28741 on a recording medium is measured to be simultaneously 200 or more at an angle of 20°, 200 or more at an angle of 60°, and 100 or more at an angle of 85°, more preferably 400 or more at an angle of 20°, 400 or more at an angle of 60°, and 100 or more at an angle of 85°, and most preferably 600 or more at an angle of 20°, 600 or more at an angle of 60°, and 100 or more at an angle of 85°.

An image whose specular glossiness according to JIS Z8741 is measured to be simultaneously 200 to less than 400 at an angle of 20°, 200 to less than 400 at an angle of 60°, and 100 or more at an angle of 85° has a dull (matt) metallic appearance.

An image whose specular glossiness according to JIS 28741 is measured to be simultaneously 400 to less than 600 at an angle of 20°, 400 to less than 600 at an angle of 60°, and 100 or more at an angle of 85° has a metallic gloss shiny enough for an object reflected in the formed image to be slightly recognized.

An image having a metallic gloss whose specular glossiness according to JIS 28741 is measured to be simultaneously 600 or more at an angle of 20°, 600 or more at an angle of 60°, and 100 or more at an angle of 85° has a sharp metallic gloss, or “specular gloss”, shiny enough for an object reflected in the formed image to be clearly recognized.

Thus, the ink-jet recording method according to this embodiment allows formation of an image having a desired metallic gloss, from a matt image to a glossy image, by combining images having a metallic gloss whose specular glossiness according to JIS 28741 on a recording medium is measured to be simultaneously 200 or more at an angle of 20°, 200 or more at an angle of 60°, and 100 or more at an angle of 85°.

On the other hand, an image whose specular glossiness is not measured to be 200 or more at an angle of 20°, 200 or more at an angle of 60°, and 100 or more at an angle of 85° shows no metallic gloss and looks gray when visually observed.

The amount of ink composition ejected onto the recording medium is preferably 0.1 to 100 mg/cm², more preferably 1.0 to 50 mg/cm², in view of providing a metallic gloss and also in view of printing process and cost.

The metallic pigment forming the image on the recording medium preferably has a dry weight of 0.0001 to 3.0 mg/cm² in view of metallic glossiness, printing process, and cost. The lower dry weight the metallic pigment has, the more highly metallic gloss can be formed. Accordingly, for example, such a dry weight is suitable for forming a half-mirror image on a transparent recording medium. On the other hand, the higher dry weight the metallic pigment has, the matter metallic appearance can be formed. Accordingly, for example, such a dry weight is suitable for forming a shield layer on a transparent recording medium.

Examples of methods for ejecting the ink composition include those described below.

A first method uses electrostatic attraction. According to this method, ink droplets are continuously ejected from a nozzle by applying an intense electric field between the nozzle and an acceleration electrode disposed in front of the nozzle to perform recording. The ink droplets are deflected by applying a printing information signal to deflection electrodes while passing between the deflection electrodes to perform recording, or are ejected according to a printing information signal without being deflected.

A second method is a method in which ink droplets are forcedly ejected by mechanically oscillating a nozzle with, for example, a quartz oscillator while applying a pressure to the ink with a small pump. The ink droplets are ejected and charged at the same time and are deflected by applying a printing information signal to deflection electrodes while passing between the deflection electrodes to perform recording.

A third method uses a piezoelectric device. Ink droplets are ejected by simultaneously applying a pressure and a printing information signal to the ink with a piezoelectric device to perform recording.

A fourth method uses rapid volume expansion of ink by thermal energy. Ink droplets are ejected by heating and bubbling the ink with a microelectrode according to a printing information signal to perform recording.

Although any of the above methods can be used for the ink-jet recording method according to this embodiment, the ink composition is preferably ejected by a non-heating method in view of supporting high-speed printing. That is, the first, second, and third methods are preferably used.

As the recording medium, various recording media can be used, including, but not limited to, normal paper, ink-jet paper (matte paper and glossy paper), glass, plastic films such as polyvinyl chloride films, films coated with plastic or receiving layers, metals, and printed circuit boards.

If the recording medium has an ink-receiving layer, the recording medium is preferably subjected to printing without heating to avoid thermal damage.

On the other hand, if the recording medium has no ink-receiving layer, the recording medium is preferably subjected to printing by heating for higher drying speed and higher glossiness.

The recording medium may be heated, for example, by a heating method in which the recording medium is brought into contact with a heat source or by a noncontact heating method in which the recording medium is irradiated with, for example, infrared light or microwave (radiation with a maximum wavelength around 2,450 MHz) or in which hot air is blown on the recording medium.

The heating is preferably performed before, at the same time as, and/or after printing. In other words, the recording medium may be heated before, at the same time as, after, or throughout printing. The heating temperature is preferably 30° C. to 80° C., more preferably 40° C. to 60° C., depending on the type of recording medium.

Recorded Material

A recorded material according to this embodiment is provided by recording using the above ink-jet recording method. With the above ink-jet recording method and the above ink set, a recorded material having a highly metallic specular gloss can be provided. In addition, any metallic gloss, from a specular gloss to a matt appearance, can be simultaneously formed because the ink compositions of the ink set have different metallic pigment concentrations.

### Examples

### Examples 1 to 10 and Comparative Examples 1 and 2

1. Preparation of Metallic Pigment Dispersion

A resin-layer coating solution containing 3.0% by weight of cellulose acetate butyrate (butylation rate: 35% to 39%; manufactured by Kanto Chemical Co., Inc.) and 97% by weight of diethylene glycol diethyl ether (manufactured by Nippon Nyukazai Co., Ltd.) was uniformly applied onto a PET film having a thickness of 100 μm by bar coating and was dried at 60° C. for ten minutes to form a resin-layer thin film on the PET film.

Next, an aluminum deposited layer having an average thickness of 20 nm was formed on the resin layer using a vacuum evaporator (the VE-1010 vacuum evaporator manufactured by Vacuum Device Inc.).

The stack thus formed was simultaneously subjected to releasing, pulverization, and dispersion in diethylene glycol diethyl ether using the VS-150 ultrasonic homogenizer (manufactured by AS ONE Corporation) to yield a pigment dispersion containing a metal pigment, where the total ultrasonic dispersion time was 12 hours. The aluminum (metal) content of the dispersion was about 50 g/L.

Next, 3-methacryloxypropyltrimethoxysilane (KBM-503, manufactured by Shin-Etsu Chemical Co., Ltd.) was added to the pigment dispersion to a concentration of 0.025 mol/L and was allowed to react at 20° C. for 24 hours to prepare a metallic pigment dispersion. The metal pigment had a 50% average particle size (R50) of 1.83 μm and a thickness Z of 0.02 μm, and R50/Z was 91.5.

The resultant metallic pigment dispersion was filtered through a PP pleated capsule filter (CCP-3-ClB, manufactured by Advantec) to remove coarse particles. The filtrate was then put into a round-bottomed flask, and a rotary evaporator was used to remove diethylene glycol diethyl ether, thus concentrating the metallic pigment dispersion. Subsequently, the concentration of the metallic pigment dispersion was adjusted. Thus, a 5% by weight metallic pigment dispersion 1 was prepared.

As Example 2, additionally, a by weight metallic pigment dispersion 2 was prepared in the same manner as in Example 1 except that 3-methacryloxypropyltrimethoxysilane was added to the pigment dispersion to a concentration of 0.05 mol/L.

As Comparative Example 1, additionally, a metallic pigment dispersion 3 containing a metallic pigment was prepared in the same manner as in Example 1 except that 3-methacryloxypropyltrimethoxysilane was not added.

2. Preparation of Metallic Pigment Ink Composition

The metallic pigment dispersions thus prepared were used to prepare metallic pigment ink compositions having the compositions shown in Table 1. After an ink solvent was prepared by mixing and dissolving additives in a solvent, the metallic pigment dispersions were added to the ink solvent and were mixed and stirred with a magnetic stirrer at normal temperature and pressure for 30 minutes to prepare the metallic pigment ink compositions.

In Table 1, the diethylene glycol diethyl ether (DEGDE) and the tetraethylene glycol dimethyl ether (TEGDM) used were manufactured by Nippon Nyukazai Co., Ltd., the γ-butyrolactone used was manufactured by Kanto Chemical Co., Inc., and the cellulose acetate butyrate used was manufactured by Acros Organics (butylation rate: 35% to 39%). The values are expressed in percent by weight.

TABLE 1

| | | | Comparative |
|---|---|---|---|
| | Example 1 | Example 2 | Example 1 |
| Metallic pigment dispersion 1 | 1.0 | | |
| (solid content) | | | |
| Metallic pigment dispersion 2 | | 1.0 | |
| (solid content) | | | |
| Metallic pigment dispersion 3 | | | 1.0 |
| (solid content) | | | |
| Diethylene glycol diethyl ether | 68.5 | 68.5 | 68.5 |
| γ-Butyrolactone | 15.0 | 15.0 | 15.0 |
| Tetraethylene glycol dimethyl ether | 15.0 | 15.0 | 15.0 |
| Cellulose acetate butyrate | 0.5 | 0.5 | 0.5 |

3. Evaluation

### (1) Measurement of Heat Resistance

A heat resistance evaluation was performed by sealing the ink compositions of Examples 1 and 2 and Comparative Example 1 in bag-shaped transparent hermetic containers in an airtight manner, storing the ink compositions at 40° C. for one week for heat resistance test 1, 50° C. for one week for heat resistance test 2, and 60° C. for one week for heat resistance test 3, and visually checking whether bubbles occurred. The case where no bubbles were observed was determined as “A” (excellent), the case where the volume of bubbles was less than 1 cc was determined as “B” (good), and the case where the volume of bubbles was not less than 1 cc was determined as “C” (poor). The results are shown in Table 2.

(2) Measurement of Water Resistance

Samples were prepared using the metallic pigment dispersions 1, 2, and 3 by adding 20 g of metallic pigment dispersion to 80 g of ion exchange water so that the aqueous dispersion contained 1% by weight of metal pigment (the sample containing the metallic pigment dispersion 1 is referred to as Example 3, the sample containing the metallic pigment dispersion 2 is referred to as Example 4, and the sample containing the untreated metallic pigment dispersion 3 is referred to as Comparative Example 2). Subsequently, a heat resistance evaluation was performed by sealing the samples in bag-shaped transparent hermetic containers in an airtight manner, as in the heat resistance test, storing the samples at 20° C. for one week for water resistance test 1 and 40° C. for one week for water resistance test 2, and visually checking whether bubbles occurred. The case where no bubbles were observed was determined as “A” (excellent), the case where the volume of bubbles was less than 1 cc was determined as “B” (good), and the case where the volume of bubbles was not less than 1 cc was determined as “C” (poor). The results are shown in Table 3.

TABLE 2

| | Heat resistance | Heat resistance | |
|---|---|---|---|
| | test 1 | test 2 | Heat resistance test 3 |
| | 40° C., 1 w | 50° C., 1 w | 60° C., 1 w |
| Example 1 | A | A | A |
| Example 2 | A | A | A |
| Comparative | A | C | C |
| Example 1 | | | |

TABLE 3

| | Water resistance test 1 | Water resistance test 2 |
|---|---|---|
| | 20° C., 1 w | 40° C., 1 w |
| Example 3 | A | A |
| Example 4 | A | A |
| Comparative Example 2 | C | C |

The heat resistance test and the water resistance test were also performed on metallic pigment dispersions 4 to 9 (Examples 5 to 10) prepared using Compounds 2 to 7 shown in Table 4 below (all manufactured by Shin-Etsu Chemical Co., Ltd.; the names of products are shown in the table) instead of 3-methacryloxypropyltrimethoxysilane (Compound 1). Table 4 also shows the names of the functional groups corresponding to the “group having an unsaturated double bond”. In addition, Table 5 shows the correspondence between the metallic pigment dispersions 4 to 9 and Examples 5 to 10 (measurement of heat resistance and water resistance).

Heat resistance test 4 was performed by storing the ink compositions at 60° C. for one week and visually checking whether bubbles occurred. Water resistance test 3 was performed by storing samples at 40° C. for one week and visually checking whether bubbles occurred. The case where no bubbles were observed was determined as “A” (excellent), the case where the volume of bubbles was less than 1 cc was determined as “B” (good), and the case where the volume of bubbles was not less than 1 cc was determined as “C” (poor). The same tests were also performed on the untreated metallic pigment dispersion 2 (Comparative Example 2). The results are shown in Table 6.

TABLE 4

| | | Name of | | Functional |
|---|---|---|---|---|
| No. | Name of compound | product | Structural formula | group |
| Compound 1 | 3-Methacryloxypropyltrimethoxysilane | KBM-503 | 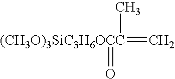 | Methacryloxy |
| Compound 2 | 3-Acryloxypropyltrimethoxysilane | KBM-5103 | 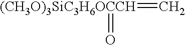 | Acryloxy |
| Compound 3 | 3-Methacryloxypropylmethyldiethoxysilane | KBE-502 | 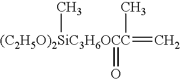 | Methacryloxy |
| Compound 4 | 3- Methacryloxypropylmethyldimethoxysilane | KBM-502 | 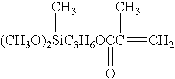 | Methacryloxy |
| Compound 5 | Vinyltrimethoxysilane | KBM-1003 | (CH₃O)₃SiCH═CH₂ | Vinyl |
| Compound 6 | Vinyltriethoxysilane | KBE-1003 | (C₂H₅O)₃SiCH═CH₂ | Vinyl |
| Compound 7 | p-Styryltrimethoxysilane | KBM-1403 | 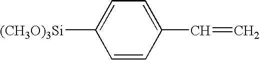 | Styryl |
| Compound 8 | 3-Methacryloxypropyltriethoxysilane | KBE-503 | 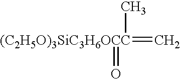 | Methacryloxy |

TABLE 5
Name of compound

| | | |
|---|---|---|
| 3-Acryloxypropyltrimethoxysilane | Metallic pigment | Example 5 |
| | dispersion 4 | |
| 3-Methacryloxypropylmethyl- | Metallic pigment | Example 6 |
| diethoxysilane | dispersion 5 | |
| 3-Methacryloxypropylmethyl- | Metallic pigment | Example 7 |
| dimethoxysilane | dispersion 6 | |
| Vinyltrimethoxysilane | Metallic pigment | Example 8 |
| | dispersion 7 | |
| Vinyltriethoxysilane | Metallic pigment | Example 9 |
| | dispersion 8 | |
| p-Styryltrimethoxysilane | Metallic pigment | Example 10 |
| | dispersion 9 | |

TABLE 6

| | Water resistance test 4 | Water resistance test 3 |
|---|---|---|
| | 60° C., 1 w | 40° C., 1 w |
| Example 5 | A | A |
| Example 6 | A | B |
| Example 7 | A | A |
| Example 8 | A | A |
| Example 9 | B | B |
| Example 10 | A | A |
| Comparative Example 2 | C | C |

According to Examples 1 to 10, as described in detail above, it was found that the surfaces of flat particles of a metal pigment can be treated with an alkoxysilane compound having a group (reactive group) having an unsaturated double bond between carbon atoms, such as a methacryloxy group, an acryloxy group, a vinyl group, or a styryl group, to improve heat resistance and water resistance while maintaining glossiness (150 or more at an angle of 20° in every example).

In general, an ink composition having a glossiness of 100 or more looks glossy when visually observed. The higher glossiness the ink composition has, the glossier the image looks when visually observed.

This is because the moiety (group) having an unsaturated double bond between carbon atoms (such as —C═CH₂) is hydrophobic (oily) so that it effectively protects the metal pigment. In addition, the metal pigment has a higher affinity for air (surface) than the organic solvent because the protective layer of the metal pigment is oily. This allows the pigment particles to be regularly aligned from the surface, thus improving orientation.

In particular, even if a nonaqueous solvent such as the above organic solvent is used for the ink composition, it contains a trace amount of water as an impurity of various solvents. For example, the ink composition contains 1.0% by weight or less of water. The treatment described above, however, protects the metal pigment with the above compound to reduce undesirable reactions due to water, including dissolution of the metal pigment, thus improving the water resistance, as described above. In addition, although the undesirable reactions tend to occur with increasing temperature, the above protection also improves the heat resistance.

Thus, the above silane compound can be used to improve printing properties. It is also effective to use Compound 8 in Table 4, which has an ethoxy group instead of the methoxy group of Compound 1 in Table 6. Similarly, it is effective to use a compound having an ethoxy group instead of the methoxy group of Compound 2 in Table 6.

According to Examples 1 and 2, additionally, the dispersions containing about 50 g/L of aluminum to which 3-methacryloxypropyltrimethoxysilane was added to concentrations of 0.025 mol/L and 0.05 mol/L both yielded excellent results (Examples 1 to 4). On the other hand, the addition of the compound in a high concentration (for example, 0.2 mol/L or more) undesirably caused aggregation of the metal particles. Hence, the treatment concentration is preferably at a relatively low level. For example, the amount of silane compound added is preferably less than 0.004 mol, more preferably 0.002 mol or less, and most preferably 0.001 mol or less, based on 1.0 g of the metal.

What is claimed is:

1. A surface-treated pigment comprising a metal pigment including flat particles whose surfaces are treated with an alkoxysilane compound having a group having an unsaturated double bond between carbon atoms.

2. The surface-treated pigment according to claim 1, wherein, if the major axis of the flat particles in a plane is defined as X, the minor axis thereof is defined as Y, and the thickness thereof is defined as Z, the 50% average particle size R50 determined in terms of equivalent circle diameter from the area of the flat particles in the X-Y plane is 0.5 to 3 μm, and R50/Z>5 is satisfied.

3. The surface-treated pigment according to claim 1, wherein the maximum particle size Rmax determined in terms of equivalent circle diameter from the area of the flat particles in the X-Y plane is 10 μm or less.

4. The surface-treated pigment according to claim 1, wherein the metal pigment is aluminum or an aluminum alloy.

5. The surface-treated pigment according to claim 1, wherein the metal pigment is formed by crushing a metal deposited film.

6. An ink composition comprising the surface-treated pigment according to claim 1, an organic solvent, and a resin.

7. The ink composition according to claim 6, wherein the concentration of the surface-treated pigment in the ink composition is 0.1% to 3.0% by weight.

8. The ink composition according to claim 6, wherein the organic solvent contains one or more alkylene glycol ethers that are liquid at normal temperature and pressure.

9. The ink composition according to claim 6, wherein the organic solvent is a mixture of an alkylene glycol diether, an alkylene glycol monoether, and a lactone.

10. The ink composition according to claim 6, wherein the resin is at least one resin selected from the group consisting of polyvinyl butyral, cellulose acetate butyrate, and polyacrylic polyols.

11. An ink-jet recording method comprising ejecting droplets of the ink composition according to claim 1 onto a recording medium to perform recording, wherein the amount of ink composition ejected onto the recording medium is 0.1 to 100 mg/cm².

12. The ink-jet recording method according to claim 11, wherein the ink composition is ejected by a non-heating method.

13. The ink-jet recording method according to claim 11, wherein the recording medium is preferably subjected to printing by heating.

14. The ink-jet recording method according to claim 13, wherein the heating temperature is 30° C. to 80° C.

15. The ink-jet recording method according to claim 13, wherein the heating is performed before, at the same time as, and/or after printing.
